(19) United States
(12) Patent Application Publication
(10) Pub. No.: US 2026/0136281 A1
(43) Pub. Date: May 14, 2026

(54) METHOD AND APPARATUS FOR TRANSMITTING AND RECEIVING CONFIGURATION INFORMATION FOR PERFORMING LOW-POWER COMMUNICATION IN A WIRELESS COMMUNICATION SYSTEM

(71) Applicant: Samsung Electronics Co., Ltd., Gyeonggi-do (KR)

(72) Inventors: Hyemin CHOE, Gyeonggi-do (KR); Kyungjun CHOI, Gyeonggi-do (KR); Hyoungju JI, Gyeonggi-do (KR); Younsun KIM, Gyeonggi-do (KR)

(73) Assignee: Samsung Electronics Co., Ltd., Gyeonggi-do (KR)

(21) Appl. No.: 19/383,085

(22) Filed: Nov. 7, 2025

(30) Foreign Application Priority Data
Nov. 8, 2024 (KR) 10-2024-0157771
Nov. 5, 2025 (KR) 10-2025-0165347

(51) Int. Cl. H04W 52/02

(52) U.S. Cl. CPC H04W 52/0216

(57) ABSTRACT

The disclosure relates to a 5^{th} generation (5G) or 6^{th} generation (6G) communication system for supporting a higher data transmission rate. A method performed by a reader in a wireless communication system comprises, transmitting, to a device, a reader-to-device (R2D) message including configuration information for a plurality of device-to-reader (D2R) messages, and receiving, from the device, the plurality of D2R messages based on the configuration information, wherein the configuration information includes scheduling information for scheduling the plurality of D2R messages, and wherein the scheduling information is based on a chip duration.

### CROSS-REFERENCE TO RELATED APPLICATION(S)

This application is based on and claims priority under 35 U.S.C. § 119 to Korean Patent Application No. 10-2024-0157771, filed on Nov. 8, 2024, and Korean Patent Application No. 10-2025-0165347 filed on Nov. 5, 2025 in the Korean Intellectual Property Office, the disclosures of each of which are incorporated herein by reference in their entireties.

### BACKGROUND

### 1. Field

The disclosure relates generally to a user equipment (UE), a base station, and a low-power communication device in a wireless communication system, and more particularly, to a method and an apparatus for receiving a transmission parameter for communicating with a UE or a base station and transmitting and receiving data to and from the UE or base station through a corresponding configuration.

### 2. Description of Related Art

5^{th} generation (5G) mobile communication technologies define broad frequency bands such that high transmission rates and new services are possible, and can be implemented not only in sub 6 gigahertz (GHz) bands such as 3.5 GHz, but also in Above 6 GHz bands referred to as millimeter wave (mm Wave) bands including 28 GHz and 39 GHz bands. In addition, it has been considered to implement 6G mobile communication technologies referred to as beyond 5G systems in terahertz (THz) bands (for example, 95 GHz to 3 THz bands) to realize transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel for NR (2-step RACH for NR) for simplifying random access procedures. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-advanced (LTE-A), LTE-Pro, high-rate packet data (HRPD) of 3GPP2, ultra-mobile broadband (UMB), IEEE 802.16e, and the like, as well as typical voice-based services.

As an example of the broadband wireless communication system, an LTE system employs an orthogonal frequency division multiplexing (OFDM) scheme in a downlink (DL) and employs a single carrier frequency division multiple access (SC-FDMA) scheme in an uplink (UL) which refers to a radio link via which a UE or a mobile station (MS) transmits data or control signals to a base station (BS, eNode B, or gNode B), and the DL refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include eMBB, mMTC, URLLC, and the like.

eMBB aims at providing a higher data rate than that supported by existing LTE, LTE-A, or LTE-Pro. For example, in the 5G communication system, eMBB must provide a peak data rate of 20 Gbps in the DL and a peak data rate of 10 gigabits per second (Gbps) in the UL for a single base station. The 5G communication system must provide an increased user-perceived data rate to the UE, as well as the maximum data rate. To satisfy such requirements, various transmission/reception technologies including a further enhanced MIMO transmission technique may be required to be improved. The data rate required for the 5G communication system may be obtained using a frequency bandwidth more than 20 megahertz (MHz) in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of things (IoT) in the 5G communication system. mMTC may have requirements, such as support of connection of a large number of UEs in a cell, enhancement coverage of UEs, improved battery time, a reduction in the cost of a UE, and the like, to effectively provide the IoT. Since the IoT provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow-ridden area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

URLLC is a cellular-based mission-critical wireless communication service that may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also may require a design for assigning a large number of resources in a frequency band to secure reliability of a communication link.

The three services of eMBB, URLLC, and mMTC in 5G may be multiplexed and transmitted in a single system. In this case, different transmission/reception techniques and transmission/reception parameters may be used between services to satisfy different requirements of the respective services. 5G is not limited to the three services described above.

The present disclosure relates to methods and apparatuses for transmissions of a plurality of D2R messages.

### SUMMARY

The disclosure has been made to address at least the above-mentioned problems and/or disadvantages and to provide at least the advantages described below.

An aspect of the disclosure is to provide an apparatus and a method capable of effectively providing services in a wireless communication system.

An aspect of the disclosure is to provide a 5G or 6G communication system for supporting a higher data transmission rate, such as ultra-high speed, ultra-low latency, and hyper-connectivity, and connection between a greater number of devices.

An aspect of the disclosure is to provide a low-power communication system that enables a device having no battery or having only a capacitor-level energy storage capability to operate.

An aspect of the disclosure is to provide a method and a device for a reader to indicate transmit device-to-reader (D2R) scheduling information to a device and for the device to perform D2R transmission to the reader according to the information.

In accordance with an aspect of the disclosure, a method performed by a reader in a wireless communication system includes, transmitting, to a device, a reader-to-device (R2D) message including configuration information for a plurality of D2R messages, and receiving, from the device, the plurality of D2R messages based on the configuration information, wherein the configuration information includes scheduling information for scheduling the plurality of D2R messages, and wherein the scheduling information is based on a chip duration.

In accordance with an aspect of the disclosure, a method performed by a device in a wireless communication system includes, receiving, from a reader, an R2D message including configuration information for a plurality of D2R messages, and transmitting, to the device, the plurality of D2R messages based on the configuration information, wherein the configuration information includes scheduling information for scheduling the plurality of D2R messages, and wherein the scheduling information is based on a chip duration.

In accordance with an aspect of the disclosure, a reader includes, at least one transceiver, at least one processor communicatively coupled to the at least one transceiver, and at least one memory, communicatively coupled to the at least one processor, storing instructions executable by the at least one processor individually or in any combination to cause the reader to, transmit, to a device, an R2D message including configuration information for a plurality of D2R messages, and receive, from the device, the plurality of D2R messages based on the configuration information, wherein the configuration information includes scheduling information for scheduling the plurality of D2R messages, and wherein the scheduling information is based on a chip duration.

In accordance with an aspect of the disclosure, a device includes, at least one transceiver, at least one processor communicatively coupled to the at least one transceiver; and at least one memory, communicatively coupled to the at least one processor, storing instructions executable by the at least one processor individually or in any combination to cause the device to, receive, from a reader, an R2D message including configuration information for a plurality of D2R messages, and transmit, to the device, the plurality of D2R messages based on the configuration information, wherein the configuration information includes scheduling information for scheduling the plurality of D2R messages, and wherein the scheduling information is based on a chip duration.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment;

FIG. 2 illustrates a structure of a frame, a subframe, and a slot in a wireless communication system according to an embodiment;

FIG. 3 illustrates when a low-power device and a reader transmit and receive a signal in a wireless communication system according to an embodiment;

FIG. 4 illustrates a basic function and a state diagram of Miller encoding according to an embodiment;

FIG. 5 illustrates a basic function of Manchester encoding according to an embodiment;

FIG. 6A illustrates waveforms available when values corresponding to a subcarrier sequence are M=2 and M=4, respectively, according to an embodiment;

FIG. 6B illustrates encoded signal waveforms observable in M=2 and M=4 when using Manchester encoding according to an embodiment;

FIG. 7 illustrates waveforms available when two repeated transmissions are applied to Manchester encoding according to an embodiment;

FIG. 8 illustrates a signal in an AIoT system according to an embodiment;

FIG. 9 illustrates an R2D signal between a reader and a device and a D2R signal scheduled by the R2D signal in an ambient IoT (AIoT) system according to an embodiment;

FIG. 10 illustrates an R2D signal between a reader and a device and a D2R signal scheduled by the R2D signal in an AIoT system according to an embodiment;

FIGS. 10A and 10B illustrate a timing of D2R transmission based on an R2D transmission according to an embodiment;

FIG. 11 illustrates an R2D signal between a reader and a device and a D2R signal scheduled by the R2D signal in an AIoT system according to an embodiment;

FIG. 12 illustrates an R2D signal between a reader and a device and a D2R signal scheduled by the R2D signal in an AIoT system according to an embodiment;

FIG. 13 illustrates an R2D signal between a reader and a device and a D2R signal scheduled by the R2D signal in an AIoT system according to an embodiment;

FIG. 14 illustrates an R2D signal between a reader and a device and a D2R signal scheduled by the R2D signal in an AIoT system according to an embodiment;

FIG. 14A illustrates an example indicating a D2R transmission based on a parameter within an R2D transmission according to an embodiment;

FIG. 14B illustrates a method of scheduling for a D2R transmission according to an embodiment;

FIG. 15 illustrates a low-power device in a wireless communication system according to an embodiment; and

FIG. 16 illustrates a reader in a wireless communication system according to an embodiment.

### DETAILED DESCRIPTION

Hereinafter, embodiments of the disclosure will be described in detail with reference to the accompanying drawings.

Descriptions related to technical contents well-known in the relevant art and not associated directly with the disclosure will be omitted for the sake of clarity and conciseness.

For the same reason, in the accompanying drawings, some elements may be exaggerated, omitted, or schematically illustrated. The size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure. Throughout the specification, the same or like reference signs designate the same or like elements. The terms which will be described below are terms defined in consideration of the functions in the disclosure, and may be different according to users, intentions of the users, or customs. Therefore, the definitions of the terms should be made based on the contents throughout the specification.

As used herein, a base station is an entity that allocates resources to terminals, and may be at least one of a gNode B, an eNode B, a Node B, a base station (BS), a wireless access unit, a base station controller, and a node on a network. A terminal may include a UE, an MS, a cellular phone, a smartphone, a computer, or a multimedia system capable of performing a communication function. The DL may refer to a radio link via which a base station transmits a signal to a terminal, and the UL may refer to a radio link via which a terminal transmits a signal to a base station. Furthermore, LTE or LTE-A systems may be described by way of example, but the embodiments of the disclosure may also be applied to other communication systems having similar technical backgrounds or channel types. Examples of such communication systems may include 5th generation mobile communication technologies (5G and NR) developed beyond LTE-A, and in the following description, the 5G may be the concept that covers the exiting LTE, LTE-A, and other similar services. In addition, based on determinations by those skilled in the art, the disclosure may also be applied to other communication systems through some modifications without significantly departing from the scope of the disclosure.

Herein, a reader is an entity that performs resource allocation to a device, and may be at least one of a base station or a UE, and a device may perform a communication function, and may include a system supplied with power based on an energy harvesting technology.

Herein, the term unit refers to a software element or a hardware element, such as a field programmable gate array (FPGA) or an application specific integrated circuit (ASIC), and the unit may perform certain functions. However, the unit does not always have a meaning limited to software or hardware and may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units may be implemented to reproduce one or more central processing units (CPUs) within a device or a security multimedia card and may include one or more processors.

A mobile communication (or wireless communication) system may provide a method for transmitting and receiving configuration information used by a low-power communication device (hereinafter, “device”) for data transmission. The configuration information may vary depending on a capability (e.g., modulation, clock accuracy, and energy retention capability) supported by the device. The device may be allocated a transmission resource from a reader based on a configuration method.

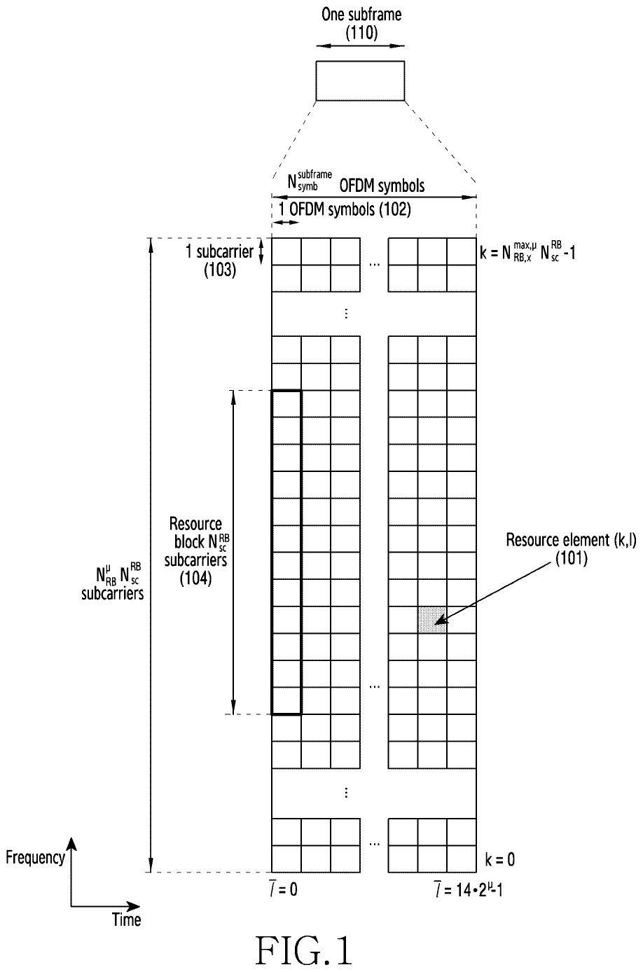

FIG. 1 illustrates a basic structure of a time-frequency domain in a wireless communication system according to an embodiment. Referring to FIG. 1, a basic structure of a time-frequency domain, which is a radio resource domain used to transmit data or control channels, in a 5G NR system, is shown.

In FIG. 1, the horizontal axis denotes a time domain, and the vertical axis denotes a frequency domain.

The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain,

$${N}_{SC}^{R B}$$

(e.g., 12) consecutive REs may constitute one resource block (RB) 104.

One subframe 100 may include multiple OFDM symbols 102 on the time axis. For example, the length of one subframe may be 1 ms.

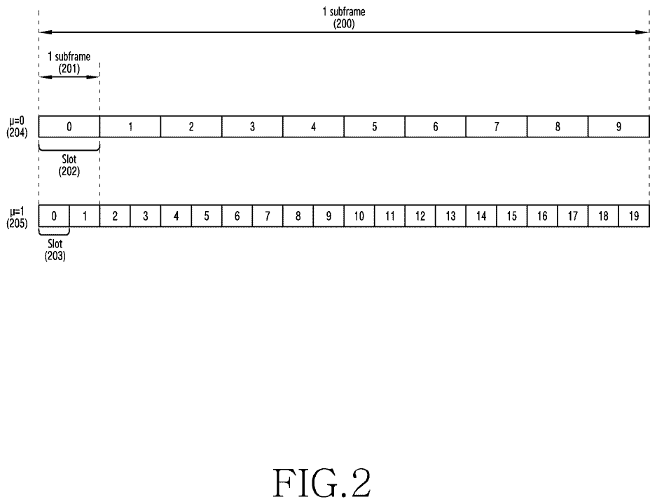

FIG. 2 illustrates a structure of a frame 200, a subframe 201, and a slot 202 in a wireless communication system according to an embodiment.

Referring to FIG. 2, one frame 200 may be defined as 10 ms and one subframe 201 may be defined as 1 ms. Therefore, one frame 200 may include a total of 10 subframes 201.

One slot 202 or 203 may be defined as multiple OFDM symbols (e.g., the OFDM symbols 102 in FIG. 1). For example, one slot 202 or 203 may be defined as

$${N}_{s y m b}^{slot}$$

(E.g., 14) OFDM symbols (e.g., the OFDM symbols 102 in FIG. 1).

One subframe 201 may include one or multiple slots 202 and 203 The number of slots 202 and 203 constituting one subframe 201 may vary depending on configuration values μ for the subcarrier spacing 204 and 205. For example, in subcarrier spacing configuration value μ=0 (204), one subframe 201 may include one slot 202. For example, in the case of the subcarrier spacing configuration value μ=1 (205), one subframe 201 may include two slots 203. That is, the number of slots per one subframe

$${N}_{slot}^{s u bframe , μ}$$

may differ depending on the subcarrier spacing configuration value u, and the number of slots per one frame

$${N}_{slot}^{frame , μ}$$

may differ accordingly.

$${N}_{slot}^{s u bframe , μ} and {N}_{slot}^{f r a m e , μ}$$

may be defined according to each subcarrier spacing configuration u as in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In the IoT, various devices are interconnected through the Internet to exchange data, and is being utilized in various fields, such as smart homes, industrial automation, healthcare, and smart cities. Most existing IoT devices operate using batteries, and the batteries need to be replaced or recharged periodically, which may increase maintenance costs and time consumption for an IoT system, and may be a major limitation, especially when the IoT system requires a large-scale deployment or is used in a difficult-to-access location. AIoT, which is a low-power communication technology, is a new type of IoT technology of harvesting energy from a surrounding environment for power supply as one of the next evolutionary stages in IoT technology. An AIoT device may be supplied with energy through light, radio waves, motions, heat, or any other power source that may be considered suitable by using an energy harvesting technology, which enables the AIoT device to operate for a long time without replacing or recharging a battery. The output of an energy harvester is typically 1 μW to hundreds of μW, which is very low compared to a maximum power of 10 mW required for communication technologies in current commercial systems. Accordingly, a need for new low-power communication technologies available for various cases using AIoT is emerging.

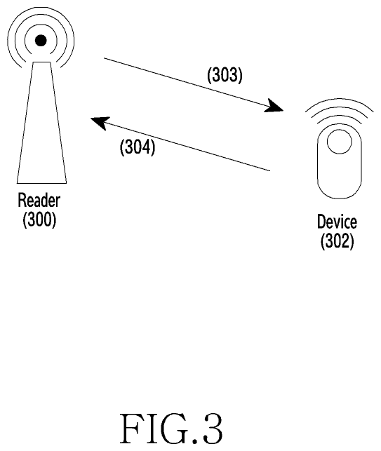

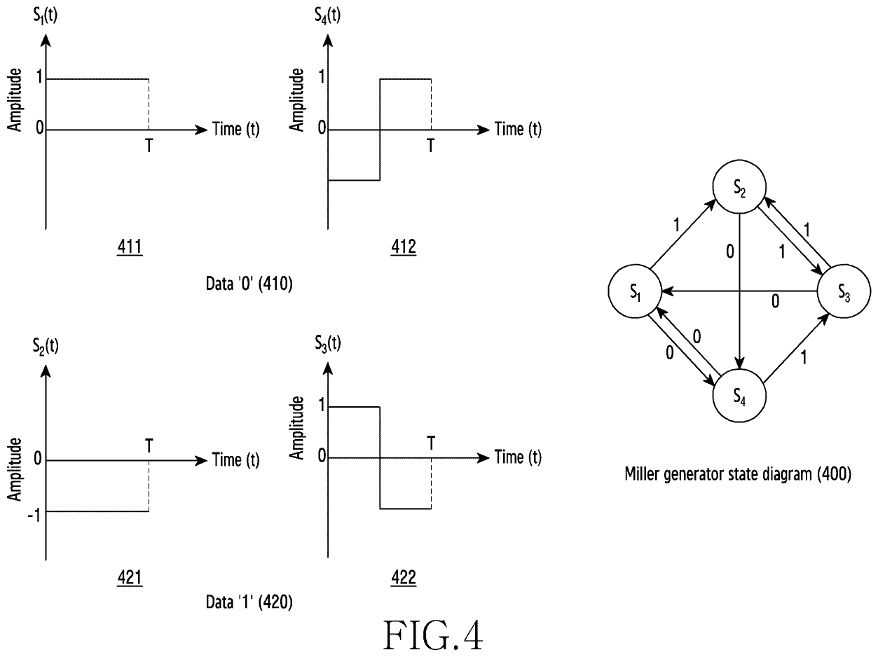

FIG. 3 illustrates when a low-power device 302 and a reader 300 transmit and receive signals 303 and 304 in a wireless communication system according to an embodiment.

Referring to FIG. 3, a reader 300 may refer to an entity that transmits and receives data to and from a low-power device 302. For example, the reader 300 may include a base station or a UE. In addition, R2D transmission or an AIoT DL 303 may refer to a wireless transmission path for a signal transmitted from the reader 300 to the low-power device 302, and D2R transmission or an AIoT UL 304 may refer to a wireless transmission path for a signal transmitted from the low-power device to the reader.

The reader 300 may indicate D2R transmission 304 of the device 302 or transmit information necessary for an operation of the device 302 or information necessary to update the state of the device 302 through R2D transmission 303.

The device 302 may report state information about the device 302 and an instruction from the reader 300 through D2R transmission 304.

An AIoT device (e.g., the device 302) is supplied with energy through energy harvesting, and may use the following two methods to generate a signal to be transmitted to the reader 300. The device 302 may use backscattering communication of generating a signal by reflecting a radio frequency (RF) signal coming from the outside to transmit data. For signal transmission from the device 302 to the reader 300 (i.e., a UL of an AIoT system), a signal transmitted from the outside to the device 302 may be referred to as a carrier wave (hereinafter, “CW”). The CW may be transmitted from a node outside the device 302 to the device 302. The device 302 may reflect a CW signal from an external node, thereby generating a UL signal to be transmitted to the reader 300. When backscattering communication is used, the device may not include a local oscillator (LO) in the internal structure, which may significantly reduce power consumption and device complexity.

The device 302 may reflect a signal and encode information stored in a memory. The reflected signal may be transmitted to the reader 300 and decoded.

The device 302 may directly generate a signal to be transmitted to the reader 300 within the device 302. For example, the device 302 may directly generate a signal using an LO within the device 302. When the device 302 directly generates the signal internally, greater power consumption may be caused and device complexity may be increased compared to when using backscattering communication.

In the AIoT system, the device 302 may utilize an amplifier in a transceiver to improve communication performance.

The device 302 may generate a signal for UL transmission by various methods, but a harmonized design that enables signal reception in terms of base station reception regardless of a UL signal generation method may be appropriate to reduce cost or complexity in system design. For example, a signal generated by reflecting a CW and a signal generated within the device may be designed to share similar signal shapes and transmission techniques, thereby enabling a receiving end to receive and interpret the signals through the same algorithm. The disclosure describes the device 302 that generates a signal by reflecting a CW. However, when a signal is generated directly within the device 302, the generated signal may be designed to have a shape similar to the signal generated by reflecting the CW, thereby applying the same reception technique when the signal is received at the reader 300. For example, when the device 302 generates a signal through CW reflection, the CW signal may be a sine wave having a single tone (frequency). The device 302 may reflect the signal by applying frequency conversion by specific frequency variance (Δf) to the CW signal of the sine wave. For example, when generating a signal within the device 302, a sine wave having a single tone may be directly generate within the device 302 and equally subjected to frequency shift (conversion), thereby generating a signal similar to the signal generated by reflecting the CW signal. For example, the signal may be generated by imitating a frequency shift-applied signal in a signal generation stage, which may enable a receiver to receive and interpret signals through the same algorithm despite different signal generation methods of the device 302, may reduce the complexity of the system, and may improve overall efficiency.

In the AIoT system, data may be encoded using line coding when transmitting a signal between the device 302 and the reader 300. Accordingly, errors in signal transmission may be reduced through data modulation and synchronization between the reader and the device may be maintained. For example, line coding methods may include FMO, Miller encoding, and Manchester encoding, but are limited thereto.

FIG. 4 illustrates a basic function 410 and 420 and a state diagram (Miller generator state diagram) 400 of Miller encoding according to an embodiment.

Referring to FIG. 4, Miller encoding may have a memory characteristic that the state of a previous bit is stored and an encoding result of a current bit varies accordingly.

In the state diagram 400 of Miller encoding, a plurality of states may be defined in line coding of Miller encoding. Any one of the plurality of states may transition to another state depending on the value of a currently encoded bit. For example, a first state (S1) may transition to a second state (S2) when the encoded bit is 1, the first state (S1) may transition to a fourth state (S4) when the encoded bit is 0, the second state (S2) may transition to a third state (S3) when the encoded bit is 1, and the second state (S2) may transition to the fourth state (S4) when the encoded bit is 0. In addition, the third state (S3) may transition to the second state (S2) when the encoded bit is 1, the third state (S3) may transition to the first state (S1) when the encoded bit is 0, the fourth state (S4) may transition to the third state (S3) when the encoded bit is 1, and the fourth state (S4) may transition to the first state (S1) when the encoded bit is 0.

Miller encoding may represent each bit (0 and 1) by using maintenance or transition of a signal. For example, in a basic function 410 corresponding to data “0” of FIG. 4, Miller encoding may represent a bit indicating 0 by using a signal 411 that maintains 1 or a signal 412 that transitions from −1 to 1. For example, in a basic function 420 corresponding to data “1” of FIG. 4, Miller encoding may represent a bit indicating 1 by using a signal 421 that maintains −1 or a signal 422 that transitions from 1 to −1.

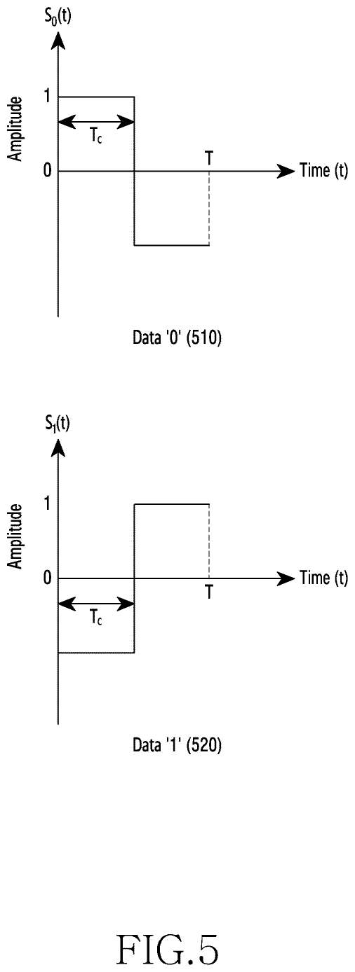

FIG. 5 illustrates a basic function of Manchester encoding according to an embodiment.

Referring to FIG. 5, Manchester encoding is a line coding method used in digital communication, and may express each bit by using transition of a signal. In a basic function 510 corresponding to data “0′” in FIG. 5, Manchester encoding may represent a bit indicating 0 by using a signal that transitions from 1 to −1. In a basic function 520 corresponding to data “1” in FIG. 5, Manchester encoding may represent a bit indicating 1 by using a signal that transitions from −1 to 1.

A time (T) required to transmit one data symbol (“0” or “1”) may be referred to herein as a “bit time” or a “bit period,” and the bit time or bit period may be defined as Tb. A smallest unit of signal transition within T corresponding to one data symbol may be referred to as a “chip,” and time length corresponding to one chip may be defined as ‘chip duration (Tc)’. Thus, Tc may refer to the minimum time unit (time duration) for D2R transmission. Tc configures a continuous signal, and each chip may have a predetermined duration and may be defined as the minimum time unit recognizable by the receiver of the device, corresponding to one component of a sequence representing a single bit. Tc can be understood as the minimum time corresponding to one component constituting a spread code sequence that represents a single bit.

When a tag receives a CW signal and then reflects the received CW signal, if the reflected signal and the received CW signal share the same frequency resource, the two signals may interfere with each other at a receiving end. Therefore, separating the reflected signal and the CW signal in a frequency domain may help improve signal reception performance. One method may be additionally considering a subcarrier sequence in line coding. When a line code and a subcarrier sequence are used for encoding, a waveform transmitted from the tag may be a form in which a base function transmittable when specific line coding is used is multiplied by a subcarrier sequence signal in a square wave form.

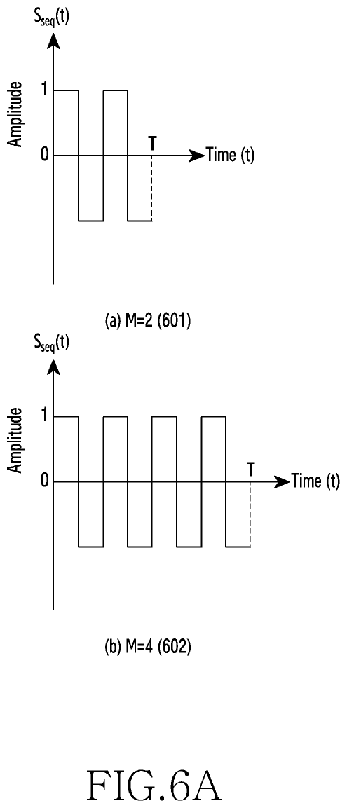

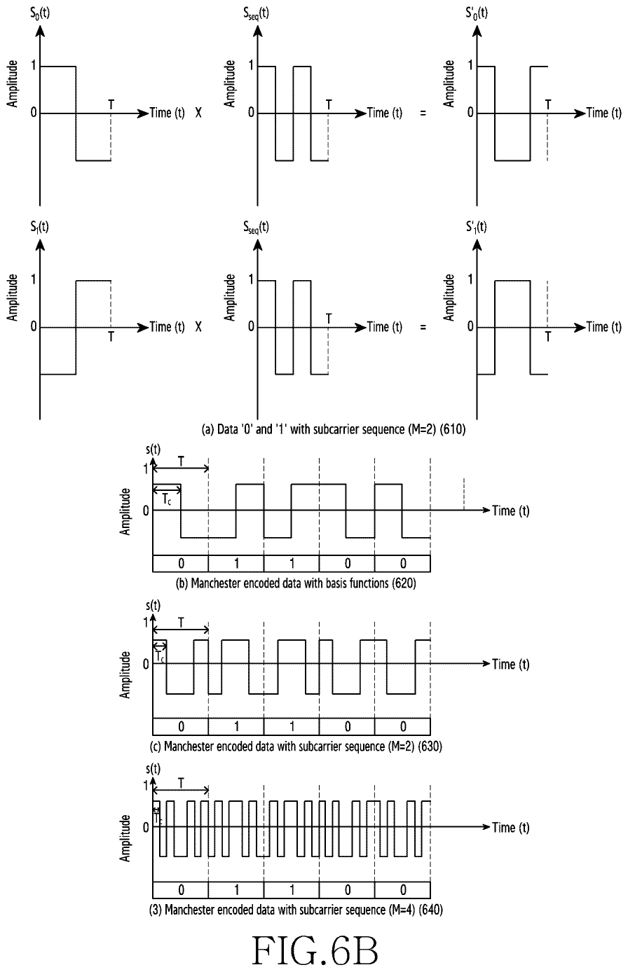

FIG. 6A illustrates waveforms available when values corresponding to a subcarrier sequence are M=2 and M=4, respectively, according to an embodiment. Referring to FIG. 6A, when M=2 is used, a waveform of example 601 may be multiplied by a base function when using line coding, and when M=4 is used, a waveform of example 602 may be multiplied against a base function when using line coding. As the value of M increases, the baseband link frequency of a generated signal may increase.

FIG. 6B illustrates encoded signal waveforms observable in M=2 and M=4 when using Manchester encoding according to an embodiment.

Referring to FIG. 6B, example 610 illustrates data waveforms that may be output for each data “0” and “1” when applying a sequence with M=2 to Manchester encoding. The encoded data signal waveforms may be determined by multiplying the sequence by a base function. When M=2, a baseband link frequency may be twice that of the base function.

Example 620 illustrates a signal waveform that may be output for a data sequence “01100” when using a base waveform without applying a subcarrier sequence to Manchester encoding.

Example 630 illustrates a signal waveform that may be output for a sequence data “01100” when applying a subcarrier sequence of M=2 to Manchester encoding.

Example 640 illustrates a signal waveform that may be output for a data sequence “01100” when applying a subcarrier sequence of M=4 to Manchester encoding.

For example, when M=2, the waveforms of example 601 of FIG. 6A may be multiplied by the base function when using line coding. For example, when M=4, the waveform of example 602 of FIG. 6A may be multiplied by the base function when using line coding.

The value of M increases, the baseband link frequency of a generated signal may increase.

A method using a subcarrier sequence may be used for Manchester, Miller, and various line coding techniques. Alternatively, even when line coding is not used, the frequency of a signal may be changed using only a subcarrier sequence.

Manchester encoding may change the frequency of a signal by changing the number of repetitions of the signal for the same period.

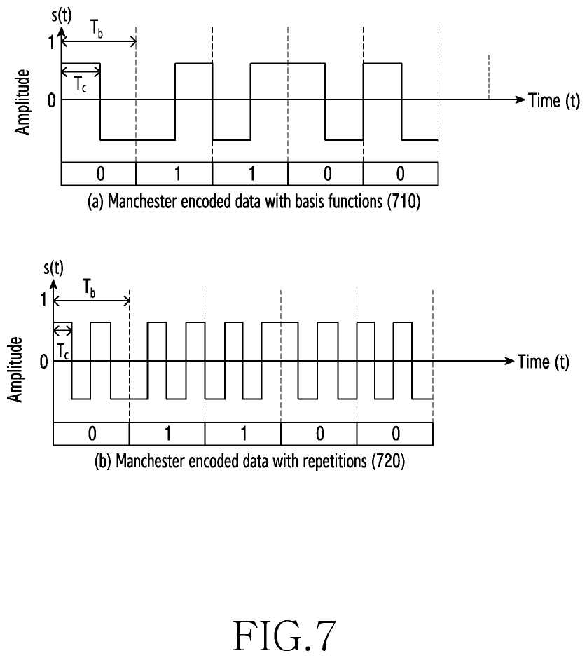

FIG. 7 illustrates performing frequency shift of a signal using repetitions in Manchester encoding according to an embodiment. Referring to FIG. 7, example 710 is an encoded signal when no repetition is used, and example 720 is an encoded signal by applying two additional repetitions.

In an AIoT system, a device collects energy required to operate through energy harvesting, and thus it may be advantageous to avoid using various physical layer channels to reduce operational complexity of the device. Therefore, a channel, such as a physical broadcast channel (PBCH) or a physical random access channel (PRACH), may not be used in the AIoT system unlike in an existing NR system. That is, since a dedicated channel for synchronization may not be used in the AIoT system, an additional element may be added to each transmission in addition to data to synchronize data transmission and reception between a reader and a device. For example, a preamble may be included in a signal.

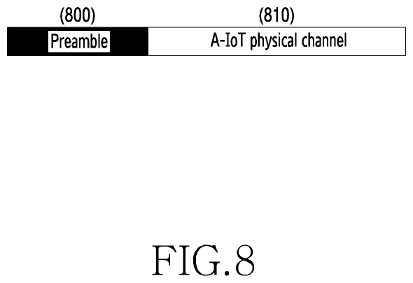

FIG. 8 illustrates a signal in an AIoT system according to an embodiment.

Referring to FIG. 8, the structure of a signal in a case of transmitting a physical layer channel in the AIoT system may include a structure in which a preamble 800 available to indicate the start point of a signal or to achieve appropriate synchronization when receiving a signal is transmitted before AIoT physical layer data 810. The structure in which the preamble 800 is transmitted before the AIoT physical layer data 810 may be utilized for both R2D transmission and D2R transmission.

A midamble or postamble may be added for various purposes to improve the accuracy of signal reception. Furthermore, these signals may be utilized for various purposes according to the design and configuration of the signals, and the structure and use of the signals are not limited to the example illustrated in FIG. 8.

Signals when transmitting a physical layer channel in the AIoT system may be configured as a binary signals expressed in a specific pattern. For example, the signals may be configured in an ON(1)-OFF(0) pattern.

### Embodiment 1: Various R2D and D2R Transmissions Configurable in AIoT System

When a reader transmits an R2D signal to a device to indicate D2R transmission, the R2D signal transmitted by the reader to the device may be related to single D2R transmission or D2R transmission for a plurality of TBs. Although it is assumed that the reader performs single R2D transmission in the disclosure, a method in which the reader performs R2D transmission is not limited thereto. For example, the reader performs two or more R2D transmissions, and information belonging to the two or more R2D transmissions may be associated with at least one D2R transmission. For example, first R2D transmission may include resource information required for the D2R transmission, and subsequent R2D transmissions may include information triggering the start of the D2R transmission. One R2D transmission may mean that the reader transmits one R2D payload, and one R2D transmission may be construed as a group of R2D transmissions that may all be referenced by at least one D2R transmission.

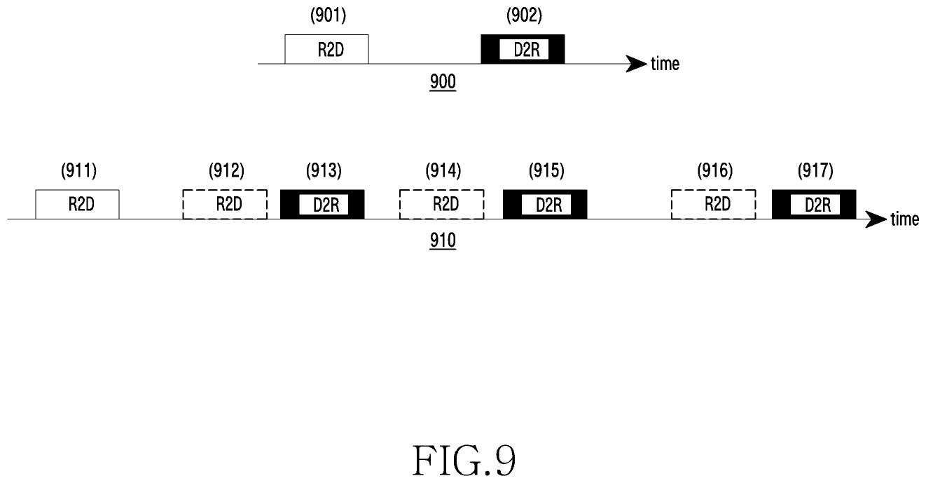

FIG. 9 illustrates various transmission methods that may occur when scheduling D2R signal transmission to a device based on an R2D transmission according to an embodiment. Referring to FIG. 9, in example 900, a reader according to an embodiment may indicate single D2R transmission 902 for a single TB by using R2D transmission 901. For example, only the single D2R transmission 902 may reference scheduling information included in the R2D transmission 901.

In example 910, the reader may indicate a plurality of D2R transmissions 913, 915, and 917 for one or more TBs by using R2D transmission 911. Examples of these transmissions may include periodic transmissions, trigger-based transmissions, repeated transmissions, or segmented transmissions.

In the periodic transmissions, the reader may instruct the device to periodically report specific information. For example, in a device utilized as a sensor, the device may periodically sense surrounding information and report the sensed surrounding information to the reader. The device may refer to control information associated with D2R transmission within the single R2D transmission 911 to perform each transmission.

In the trigger-based transmissions, the reader may instruct the device to report specific information upon receiving a trigger message. When receiving a trigger signal, the device may transmit indicated information to the reader, and may refer to initial R2D transmission for some scheduling information and refer to previously performed triggered R2D transmission for some scheduling information. In the repeated transmissions, the reader may instruct repeated transmissions to increase reception reliability of the D2R transmissions. Each transmission may refer to scheduling information initially indicating repeated transmissions within the R2D transmission.

In the segmented transmissions, the reader may determine that it is difficult to transmit all specific data in single D2R transmission considering the energy storage capacity of the device, and may instruct the device to divide and transmit the data. Alternatively, the reader may instruct the device to divide and transmit the data when it is difficult to allocate consecutive time resources for transmitting the specific data in single transmission when considering time resources allocable for D2R transmission. In this case, each transmission may refer to scheduling information initially indicating segmented transmissions within the R2D transmission.

The transmission methods described above with reference to FIG. 9 may be selected and used for various purposes, such as an occasion in which a system is used and a requirement of the system, but transmission methods according to the disclosure are not limited to the examples described above with reference to FIG. 9.

After the initial R2D transmission 911 schedules the plurality of D2R transmissions, additional R2D transmissions 912, 914, and 916 may occur and may be used to trigger each D2R transmission 913, 915, and 917 or to change or add scheduling information used for the D2R transmissions 913, 915, and 917. For example, newly received scheduling information through the additional R2D transmissions may be applied only to immediately following D2R transmission. For example, the newly received scheduling information through the additional R2D transmissions may be applied to all D2R transmissions after R2D reception. For example, the newly received scheduling information through an additional R2D transmission may be applied only to D2R transmission for a certain period or number of D2R transmissions.

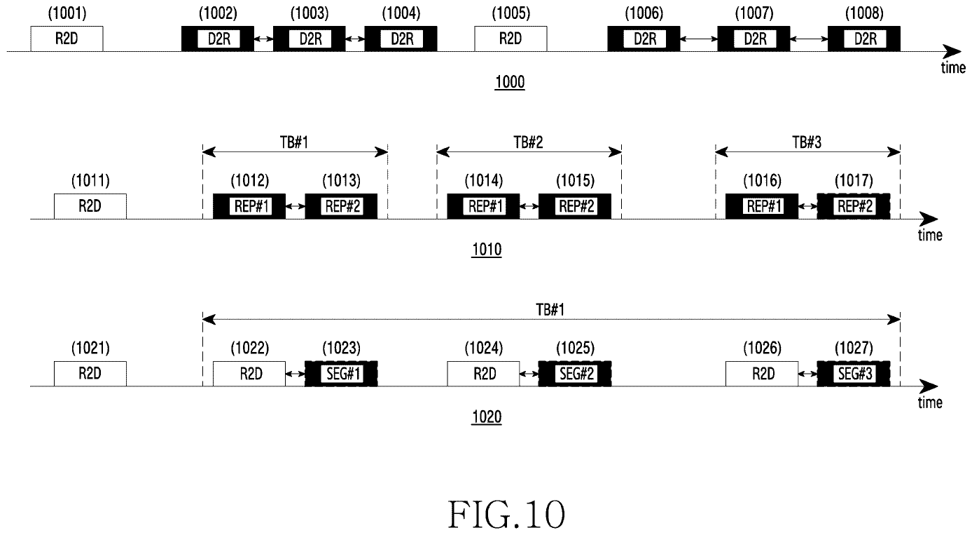

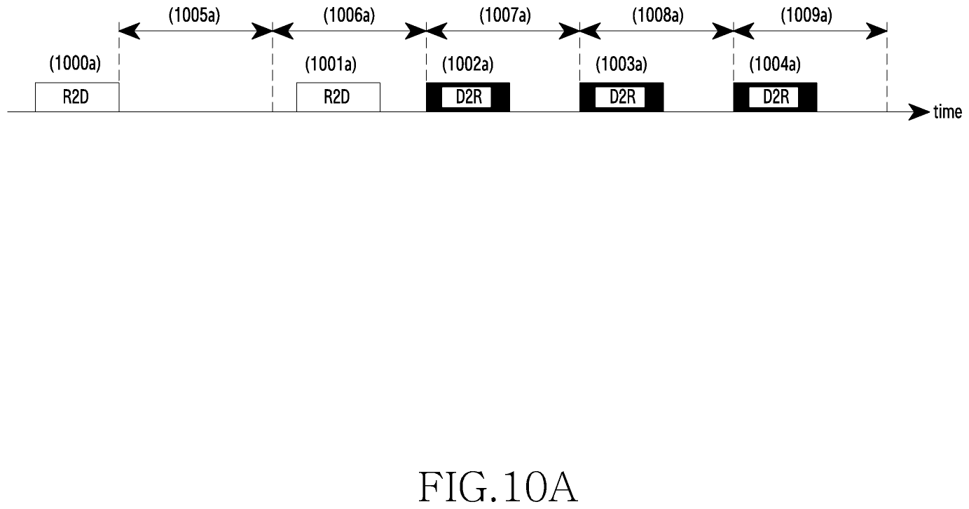

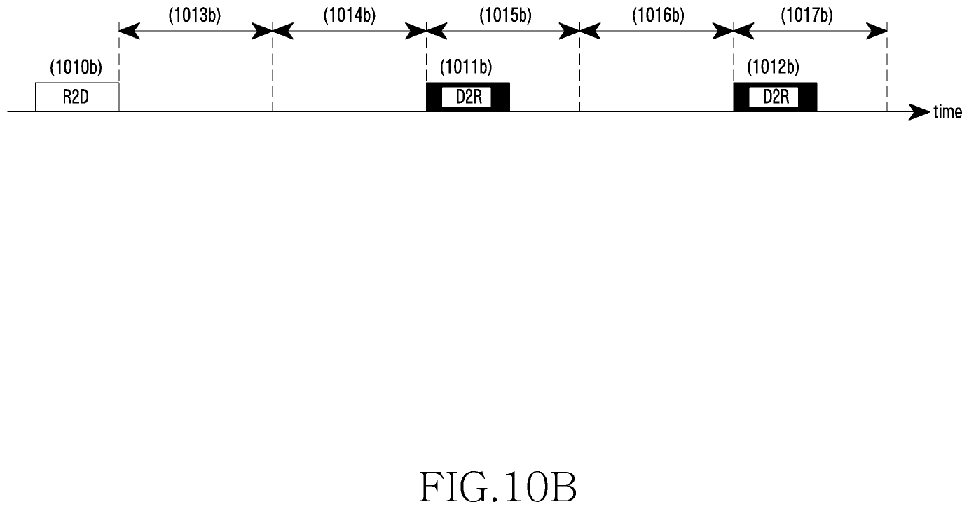

FIG. 10 illustrates an example in which a plurality of D2R transmissions that may occur in an AIoT system refers to scheduling information included in the same R2D transmission according to an embodiment.

Referring to FIG. 10, example 1000 illustrates R2D and D2R transmissions that may occur when a reader indicates D2R transmissions for a plurality of TBs to a device through R2D transmission 1001.

In example 1000, all D2R transmissions 1002, 1003, 1004, 1006, 1007, and 1008 may refer to scheduling information included in R2D transmission 1001 that initially schedules the transmissions. The reader may change the scheduling information by the initial R2D transmission 1001 through additional R2D transmission 1005. A transmission period of subsequent D2R transmissions 1006, 1007, and 1008 is changed through the additional R2D transmission 1005. As the transmission period of the D2R transmissions 1006, 1007, and 1008 is changed through the additional R2D transmission 1005, the transmission period of the D2R transmissions 1006, 1007, and 1008 after the additional R2D transmission 1005 may be longer than a transmission period of D2R transmissions 1002, 1003, and 1004 before the additional R2D transmission 1005 occurs.

Example 1010 illustrates R2D and D2R transmissions that may occur when the reader indicates D2R transmissions for a plurality of TBs via R2D transmissions 1011 to the device and indicates repeated transmissions for each TB.

In example 1010, the reader according to an embodiment may instruct the device to perform two repeated transmissions for each of TB #1, TB #2, and TB #3 via the R2D transmissions 1011. For example, two D2R transmissions 1012 and 1013 may be associated with TB #1, two D2R transmissions 1014 and 1015 may be associated with TB #2, and two D2R transmissions 1016 and 1017 may be associated with TB #3.

Example 1020 illustrates R2D and D2R transmissions that may occur when the reader indicates D2R transmission for one TB via R2D transmission 1021 to the device and indicates segmented transmissions of the TB.

In example 1020, the device may transmit TB #1 by three segmented transmissions 1023, 1025, and 1027. For example, operations, such as channel coding, CRC addition, and line coding application, may be performed once on TB #1 before segmentation, and then TB #1 may be divided into three segmented transmissions. The operations may not be performed before the segmentation, but may be performed on each segmented data. Some operations may be performed before the segmentation, and some operations may be performed after the segmentation.

In example 1020, three additional R2D transmissions 1022, 1024, and 1026 may be performed for a triggering purpose to determine timing to perform the respective segmented transmissions 1023, 1025, and 1027.

The device may perform D2R transmission after receiving each triggering signal. Information about a time interval at which the device needs to perform D2R transmission after receiving each triggering signal may be included in the R2D 1021 initially indicating the segmented transmissions or in the additional R2D transmissions 1022, 1024, and 1026 for the triggering purpose.

Examples of R2D and D2R transmissions are not limited to the illustrated examples. For example, the reader and the device may support transmission using a combination of at least two of the illustrated examples.

### Embodiment 2: Scheduling Information Required for D2R Transmission

Scheduling information required for D2R transmission may be included in R2D transmission. For example, the scheduling information required for D2R transmission may include the number of TBs that refer to the scheduling information of initial R2D transmission, the number of repeated or segmented transmissions for each TB, and information about a time resource occupied by each transmission as described above, but is not limited thereto. For example, the scheduling information may also include information about time at which the D2R transmission starts.

The information about the time at which the D2R transmission starts may be referred to herein as “time information.” The time information may be implicitly or explicitly indicated by R2D data, or may be indicated by utilizing a portion of a signal waveform used for at least one of a preamble, a midamble, a postamble, and a data part used in the R2D transmission as information. The time information may specifically include timing information for starting the D2R transmission. Alternatively, the time information may include time information indicating a maximum time between specific transmission that has previously occurred and D2R transmission to be performed subsequently. The indicated time information may be applied based on a time point at which transmission of at least one part of the R2D or D2R transmission starts or a time point at which transmission of at least one part of the R2D or D2R transmission ends. For example, the D2R transmission may be performed by calculating a maximum time or a transmission timing from a time point at which transmission or reception of a continuing physical channel for the R2D transmission starts rather than a preamble of the R2D transmission.

The time information may be expressed as a specific time. For example, the time information may be provided as a specific time, such as 1 ms or 10 ms, but a method for providing the time information is not limited thereto. For example, the time information may be provided in a unit of the duration of at least one of 1 or 0 included in at least one part used for the D2R transmission, provided in a unit of the duration of at least one of 1 or 0 included in at least one part used for the R2D transmission, or indicated by including other specific time units directly in the R2D data. For example, a device may process a time unit as a chip length (Tc) used for D2R data transmission.

When processing the time unit as the Tc used for D2R data transmission, the device may indicate a specific value (K) as the information about the transmission timing for starting the corresponding D2R transmission through the R2D transmission. When indicating the specific value (K) as the information about the transmission timing for starting the D2R transmission, the device may perform the corresponding D2R transmission after waiting for a time of K*Tc from the time when the reception of the R2D physical channel starts. Alternatively, the device may receive an indication of maximum and minimum transmission times related to the start of the D2R transmission, based on the above method. For example, when the device receives Kmin and Kmax as the minimum transmission time and the maximum transmission time, respectively, the device may operate to start the D2R transmission or end the D2R transmission within a time of [Kmin, Kmax], based on a specific timing. Alternatively, these values may be indicated as specific times, such as Xmin and Xmaxms. In this case, the device may perform the indicated D2R transmission within [Xmin, Xmax] ms starting from a specific timing, or may adjust the start of the D2R transmission so that the D2R transmission ends within the corresponding period. Alternatively, when a pulse interval encoding (PIE) code is used for the R2D transmission, information related to the start of the D2R transmission may be indicated in a unit of at least one time period among the durations of 1 or 0 forming the PIE code.

The time information may include index information about some time period configured autonomously by the device. For example, the device may divide a time period by operating a timer for a predetermined length of time, based on a preset specific time (e.g., 1 ms, 1 s) or a time unit, such as Tc illustrated above, and increasing a time resource index each time the timer repeats one period. Information about the predetermined length of time may be transmitted from a reader, or may be a value agreed on in advance between the reader and the device and thus not require separate signaling. In addition, the reader may transmit index information indicating a time resource to the device. The device may adjust the start of the D2R transmission by starting the D2R transmission within the time resource indicated by an index, based on the index indicating the time resource received from the reader or by including both the start and end of the D2R transmission in the corresponding period. However, a method by which the device performs the D2R transmission based on the index is not limited thereto.

A reference point of the index indicating the time resource may be determined based on a preceding R2D signal. The preceding R2D signal may be an R2D transmission including D2R transmission parameters. Alternatively, the preceding R2D signal may be an R2D transmission including a synchronization signal that is periodically or non-periodically received from a reader. According to an embodiment, information on a time unit may also be included in the R2D transmission, or a pre-configured unit may be used such that separate signaling is not required.

Information about the time unit may also be included in the R2D transmission, or may not require separate signaling by using a preset unit.

FIGS. 10A and 10B illustrate a timing of D2R transmission based on an R2D transmission according to an embodiment.

Referring to FIG. 10a, a device according to an embodiment of the present disclosure may perform at least one D2R transmission based on an R2D signal received from a reader.

For example, the device may first receive a first R2D transmission 1000a from the reader. The first R2D transmission 1000a may include a synchronization signal for the device to acquire time synchronization with the reader. The device may set a reception completion time point of the first R2D transmission 1000a or a specific reference point within the signal as a timing reference point.

According to one embodiment, based on the timing reference point, the device may identify or define a plurality of consecutive time resources by itself.

For example, referring to FIG. 10a, a plurality (e.g., five) of time slots 1005a, 1006a, 1007a, 1008a, and 1009a may be defined. The length and boundary of each of the plurality (e.g., five) of time slots 1005a, 1006a, 1007a, 1008a, and 1009a may be pre-defined values.

Alternatively, the length and boundary of each of the plurality (e.g., five) of time slots 1005a, 1006a, 1007a, 1008a, and 1009a may be configured by the reader through the first R2D transmission 1000a and/or a separate R2D signal.

The device may sequentially assign corresponding local indexes to each of the plurality (e.g., five) of time slots 1005a, 1006a, 1007a, 1008a, and 1009a.

For example, the device may sequentially set indexes i=0, 1, 2, 3, and 4 for each of the plurality (e.g., five) of time slots 1005a, 1006a, 1007a, 1008a, and 1009a. Subsequently, the device may receive a second R2D transmission 1001a including D2R transmission parameters in a time slot 1006a corresponding to i=1 among the plurality (e.g., five) of time slots 1005a, 1006a, 1007a, 1008a, and 1009a. The D2R transmission parameters included in the second R2D transmission 1001a may include scheduling information for at least one D2R transmission to be performed later. For example, the scheduling information may include information on a time resource in which the D2R transmission indicated based on the aforementioned local index is to be performed.

According to one embodiment, the scheduling information may include information explicitly indicating indexes corresponding to a plurality of time slots in which the D2R transmission is to be performed. For example, when the second R2D transmission 1001a is transmitted in the time slot 1006a corresponding to i=1, the D2R transmission parameters may include a list of indexes (e.g., i=2, 3, and 4) corresponding to the time slots for the D2R transmissions. The device may perform D2R transmissions 1002a, 1003a, and 1004a respectively in the three slots 1007a, 1008a, and 1009a based on the D2R transmission parameters.

According to one embodiment, the scheduling information may include information on a start index and/or a period. For example, the D2R transmission parameters may include information indicating i=2 as the start index, a period of one slot, and a repetition count of three. In this case, the device may perform a total of three D2R transmissions 1002a, 1003a, and 1004a in three slots 1007a, 1008a, and 1009a starting from the i=2 slot 1007a with an interval of one slot. In another example, the D2R transmission parameters may indicate i=2 as the start index, a period of one slot, and a data division count of three. In this case, the D2R transmission parameters may specify the size of each divided data portion, or the size of each divided data portion may be determined according to a pre-defined rule between the device and the reader. Accordingly, the device may perform three D2R transmissions respectively in the three slots 1007a, 1008a, and 1009a starting from the i=2 slot 1007a with an interval of one slot.

Referring to FIG. 10b, according to one embodiment, a single R2D transmission may be used for both functions of setting a timing reference point and delivering D2R transmission parameters. For example, referring to FIG. 10b, a device may receive a first R2D transmission 1010b from a reader.

According to one embodiment, the first R2D transmission 1010b may include a synchronization signal and D2R transmission parameters for scheduling D2R transmissions to be performed later. Accordingly, after receiving the first R2D transmission 1010b, the device may determine or identify a plurality of time slots 1013b, 1014b, 1015b, 1016b, and 1017b based on the reception completion time of the first R2D transmission 1010b. The device may set (or determine) local time indexes corresponding to each of the plurality of time slots 1013b, 1014b, 1015b, 1016b, and 1017b. In addition, the device may receive the D2R transmission parameters through the first R2D transmission 1010b. For example, when the D2R transmission parameters indicate that the D2R transmission starts from the slot 1015b corresponding to index i=2 and that the period is 2, the device may initiate D2R transmissions in the slot 1015b corresponding to index i=2 and the slot 1017b corresponding to index i=4.

Furthermore, in one embodiment, an additional signal for synchronization of the device may be transmitted from the reader to the device. In this case, the transmission position of the synchronization signal may be indicated in advance by the reader to the device, or may be determined according to a predefined rule. The device may set a timing reference point using the first R2D transmission 1010b and, at the same time, improve synchronization performance by using an additional R2D signal.

When the reader transmits a signal to the device in an AIoT system, the signal may be generated by utilizing a time resource allocation method of a conventional NR system. For example, when the reader generates a signal to be transmitted to the device, the reader may allocate a time resource for R2D transmission, based on a time unit, such as a slot or symbol unit of the conventional NR system. However, a D2R signal transmitted by the device to the reader may be difficult to be based on the time unit of the conventional NR system, because the device does not include a high-complexity component, such as a fast Fourier transform (FFT)/inverse FFT (IFFT), and thus is unable to generate an OFDM-based signal used in the conventional NR system.

Therefore, when the device generates a D2R signal, a time resource for the D2R signal may be allocated using other information associated with the D2R signal instead of a slot or symbol unit. For example, at least one pieces of information among the length of data included in D2R transmission, the length of a cyclic redundancy check (CRC), the type of line coding used, the time length of a basic function according to the type of line coding, a coding rate, a symbol length (Tb), or a chip length (Tc) may be used for allocation of the time resource for the D2R signal. For example, when the length of data included in one D2R transmission is X, the length of a CRC is Y, a coding rate is R, Manchester encoding is used, a chip length in a basic function is Tc, and the value of M is considered for a subcarrier sequence considered for frequency shifting of a signal, the device, a time resource required for the device to transmit a D2R signal may be calculated as TD2R=(X+Y)×2×(1/R)×M×Tc. Tc and Tb may be defined as a relationship of Tc=Tb/(2×M) with respect to at least Miller encoding or Manchester code. Therefore, a base station may indicate the value of Tb instead of Tc to the device, thereby calculating the time resource according to TD2R=(X+Y)×(1/R)×Tb.

D2R scheduling information may be received from an R2D signal. The reader may transmit the R2D signal including the D2R scheduling information to the device. Some information of the D2R scheduling information may not be included in R2D transmission by using a fixed configuration, or may be determined by other configuration information values. For example, the CRC length may be automatically determined based on a data size. For example, the coding rate may always employ only a fixed value.

An available option for configuration information associated with D2R scheduling may be agreed in advance between the device and the reader, and only an indication value indicating the agreed option may be included in R2D transmission. For example, the available option may be shared in advance by the reader with the device via the R2D transmission. For example, the available option may be hard-wired in the device and thus not require separate configuration.

The chip length may employ a time length obtainable from at least one part of R2D or D2R transmission, similarly to when indicating time information between two different transmissions. For example, the duration of a signal (“0” or “1”) appearing first in a preamble of R2D transmission may be used as the chip length. Alternatively, information about the chip length may be separately indicated in R2D transmission. Alternatively, the chip length may be calculated through one or more transmission parameters, such as Tb and M values, for determining the frequency of a signal transmitted by the device.

When a plurality of D2R transmissions refers to scheduling information within the same one R2D signal, the scheduling information in the R2D signal may be separately provided for each D2R transmission, or may indicate that one scheduling parameter is equally used for some D2R transmissions and indicate other parameters separately.

To reduce energy required for a UE to monitor R2D reception and to reduce the number of R2D transmissions, scheduling parameters for a plurality of related D2R transmissions may be transmitted in a bundle to the device. When the scheduling parameters for the plurality of related D2R transmissions are transmitted in a bundle to the device, the parameters may be applied equally to all different D2R transmissions, such as repeated transmissions, periodic transmissions, and segmented transmissions, but are not limited thereto. For example, the parameters may be applied equally only to some D2R transmissions, such as repeated transmissions or segmented transmissions for one TB, of all D2R transmissions, and a separate parameter may be indicated for each D2R transmission group.

To more flexibly utilize a time resource, some common scheduling parameters may be transmitted first, and then a scheduling parameter may be separately indicated for one or more subsequent D2R transmissions. For example, additional R2D transmission may operate as a trigger for D2R transmission. For example, indicated scheduling information may be used equally for all D2R transmissions until next R2D transmission occurs, or may be indicated differently for each group of D2R transmissions divided by group before next D2R transmission occurs.

The scheduling information may include configuration information that determines a time resource or a frequency resource of D2R transmission. For example, the scheduling information may include at least one of a data size, the number of repeated or segmented transmissions, a transmission period, a chip length, or an M value indicating the number of repetitions of a subcarrier sequence or Manchester code, but the configuration information included in the scheduling information is not limited thereto.

Scheduling information may be indicated separately for each parameter or indicated using an indicator for a parameter group. For example, a specific value of an indicator may indicate a fixed data size, a fixed M value, and a fixed chip length for D2R transmission to the device. For example, information on a frequency resource may be implicitly or inherently indicated based on an M value and a bit time. In this case, the bandwidth or location of the frequency to be used by the device may be determined according to Tc that is determined (or identified) based on the M value and the bit time. Thus, the frequency resource may be indirectly allocated without a separate explicit indication of the frequency resource. Alternatively, for example, information on the frequency resource may be explicitly indicated. For instance, when the device has the capability to utilize its own local oscillator (LO) for direct frequency shifting, information on the frequency resource may be explicitly indicated. For example, the reader may transmit to the device an index indicating one of a plurality of pre-defined frequency channels. Alternatively, a common reference frequency may be broadcast throughout a cell or system, and the reader may indicate to each device an individual frequency offset value from the reference frequency. The device may determine its target transmission frequency by adding the received offset value to the reference frequency. Alternatively, a set of frequency resources available for D2R transmission may be pre-defined or configured to the device, for example, through system information. The reader may transmit only an index indicating a specific resource within the available resource pool to the device, thereby reducing signaling overhead.

In one embodiment, the reader may indicate to the device the explicit frequency resource information together with the M value and the Tb value. In this case, based on the explicit frequency resource information, a common reference frequency (fc) may first be determined. Subsequently, based on the Tb and M values, a fine frequency offset (foffset) for the D2R signal may be generated from the fc according to the determined (or identified) Tc. Accordingly, the final transmission frequency of the device may be determined based on the combination of fc and foffset.

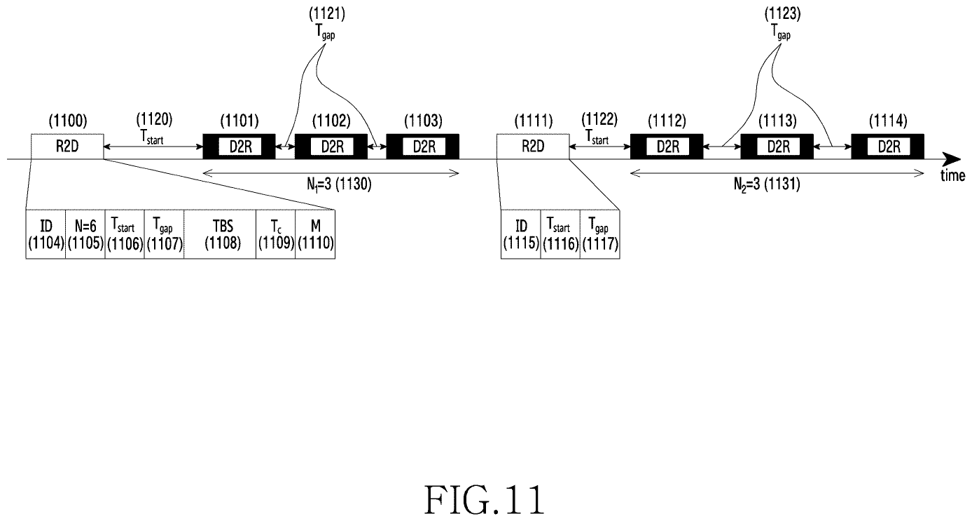

FIG. 11 illustrates a parameter in R2D transmission indicating D2R transmission according to an embodiment.

Referring to FIG. 11, an initially transmitted R2D 1100 may indicate a periodic report on specific information to a device.

The initial R2D transmission 1100 may include an ID field 1104 indicating information about the device or a message. The ID field 1104 may include information, such as an ID of the device, an ID of a device group, an ID recognizable by all devices receiving the ID field, or a random ID, thereby controlling a device group receiving the message. The ID field may also include an indicator indicating the format of the R2D transmission. For example, the indicator indicating the format of the R2D transmission may indicate the format of the R2D transmission, thereby enabling the device to identify information included in the R2D transmission with a relatively small number of bits.

The initial R2D transmission 1100 may include a field indicating the number of D2R transmissions to be performed by the device. For example, in FIG. 11, a reader indicates a total of N=6 1105 D2R transmissions 1101, 1102, 1103, 1112, 1113, and 1114 to the device, which may be transmissions associated with different TBs.

The reader may indicate a timing 1120 at which the device starts D2R transmission by using Tstart 1106.

The reader may indicate a time gap 1121 between D2R transmissions when the device performs periodic transmissions by using Tgap 1107.

Tstart and Tgap may be determined as integer values in a unit of Tc 1109 or a multiple of Tc 1109, integer values in a unit of the length of a specific time period identifiable in one or more parts within the R2D, or specific time values.

Alternatively, according to one embodiment, Tgap may be replaced by periodicity information of each D2R transmission. In this case, the periodicity information of each D2R transmission may include information regarding, for example, the interval between the start times of consecutive D2R transmissions. The periodicity information of each D2R transmission may be determined (or identified) based on an integer value in units of Tc 1109 or a multiple thereof, an integer value in units of a specific time duration identifiable in one or more parts of the R2D transmission, and/or a specific time value.

The reader may indicate a data size for each D2R transmission to the device via a transport block size (TBS) 1108. For example, the TBS 1108 may indicates a specific value or be expressed as an indicator of a predetermined value, and may be transmitted from the reader to the device. The device may determine a data size for D2R transmission, based on the TBS 1108 received from the reader, but the size of D2R transmission actually performed by the device may vary depending on a factor, such as channel coding and a CRC length.

The reader may indicate a chip length, Tc 1109, to the device. Tc 1109 may be a specific time length, or may be indicated by an indicator indicating one or more values from a list of available values.

The reader may indicate a value of M 1110 to the device. The value of M may determine the number of repetitions of a subcarrier sequence or Manchester code, thereby affecting the number of chips belonging to the length of one symbol (Tb) and the chip length, and may also affect a frequency resource for D2R transmission.

A transmission parameter not specifically included in the initial R2D transmission 1100 illustrated in FIG. 11 may be configured the same for all D2R transmissions, but is not limited thereto. For example, the transmission parameter not specifically included in the initial R2D transmission 1100 may be determined depending on some indicators within the ID field 1104.

After receiving N₁=3 1130 D2R signals, the reader may transmit an additional R2D signal 1111 to change a D2R transmission period. Similar to the initially transmitted R2D signal 1100, the additional R2D signal 1111 may include an ID field 1115, Tstart 1116 indicating a timing 1122 to start transmission of a next D2R signal 1112 after receiving the additional R2D signal 1111, and Tgap 1117 indicating a time gap 1123 between subsequently transmitted D2R signals 1112, 1113, and 1114. A transmission parameter not indicated through transmission of the additional R2D signal 1111 may be used without changing a previously used configuration.

The device may transmit N₂=3 1131 D2R signals. For example, the device may transmit subsequent D2R signals 1112, 1113, and 1114 together with a transmission parameter included in the initial R2D transmission 1100 previously performed by preferentially using configuration information 1115, 1116, and 1117 included in the received additional R2D signal 1111. For example, a transmission timing 1122 for a D2R signal 1112 after the device receives the additional R2D signal 1111 may refer to Tstart 1116 in the recently received additional R2D signal 1111. For example, the time gap 1123 between transmissions of the D2R signals 1112, 1113, and 1114 may follow Tgap 1117 in the recently received additional R2D signal 1111. For example, a data size, Tc, or the value of M for the transmissions of the D2R signals 1112, 1113, and 1114 may refer to the information included in the previously transmitted initial R2D signal 1100.

Alternatively, according to one embodiment, Tgap may be replaced with periodicity information of each D2R transmission. The periodicity information of each D2R transmission may include information regarding, for example, an interval between the start times of consecutive D2R transmissions.

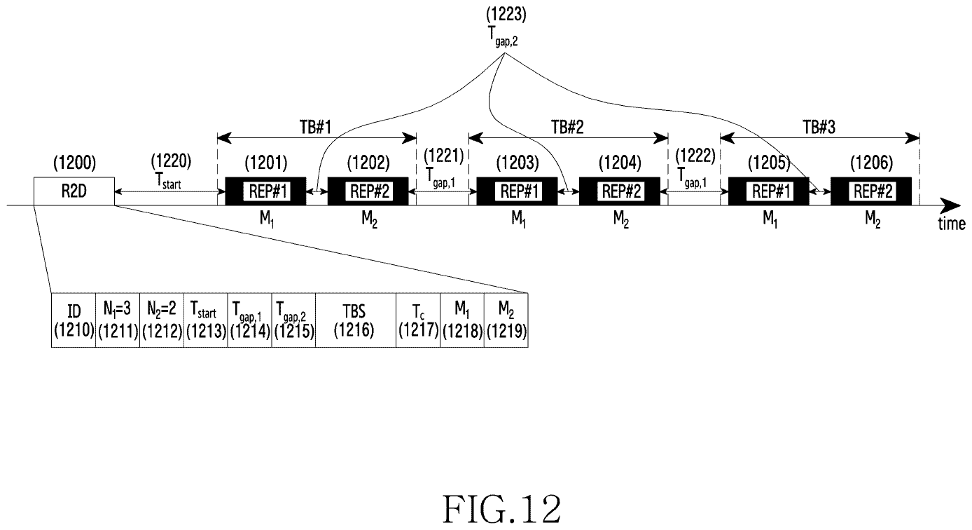

FIG. 12 illustrates when a parameter in an R2D signal transmitted by a reader indicates transmission of a D2R signal to a device according to an embodiment.

Referring to FIG. 12, an R2D signal 1200 initially transmitted by the reader may indicate a periodic report on specific information to the device.

The reader may also indicate two repeated transmissions of each TB corresponding to each report to the device.

The initially transmitted R2D signal 1200 may include an ID field 1210 indicating information about the device or a message. For example, the ID field 1210 may include information, such as an ID of the device, an ID of a device group, an ID recognizable by all devices receiving the ID field, or a random ID, thereby controlling a device group receiving the message. The ID field may also include an indicator indicating the format of the R2D transmission. For example, the indicator indicating the format of the R2D transmission may indicate the format of the R2D transmission, thereby enabling the device to identify information included in the R2D transmission with a relatively small number of bits.

The ID field 1210 may also include information about a transmission method that D2R transmission follows. For example, the ID field may include information indicating various transmission methods, such as repeated transmission, segmented transmission, and periodic transmission. For example, referring to FIG. 12, the reader may indicate D2R transmission for a total of N1=3 1211 TBs and indicate N2=2 1212 repeated transmissions for each TB to the device. For example, after receiving the R2D signal 1200, the device may perform a total of six D2R transmissions accordingly.

The reader may indicate, to the device, a timing 1220 at which the device starts D2R transmission after receiving the R2D signal 1200 by using Tstart 1213.

The reader may indicate, to the device, a time gap 1221 and 1222 between D2R transmissions for different TBs by using Tgap,1 1214.

The reader may indicate, to the device, a time gap 1223 between D2R transmissions, which are repeated transmissions, for one TB by using Tgap,2 1215.

Tstart, Tgap,1, and Tgap,2 may be determined as integer values in a unit of Tc 1217 or a multiple of Tc, integer values in a unit of the length of a specific time period identifiable in one or more parts within the R2D, or specific time values.

Tgap₁ and Tgap₂ may be replaced with periodicity information of each D2R transmission. In this case, the periodicity information of each D2R transmission may include information regarding, for example, an interval between the start times of consecutive D2R transmissions. The periodicity information of each D2R transmission may be determined (or identified) based on an integer value in units of Tc 1217 or a multiple thereof, an integer value in units of a specific time duration identifiable in one or more parts of the R2D transmission, or a specific time value.

The reader may indicate a data size for each D2R transmission to the device via a TBS 1216. For example, the TBS 1216 may indicates a specific value or be expressed as an indicator of a predetermined value, and may be transmitted from the reader to the device. The device may determine a data size for D2R transmission, based on the TBS 1216 received from the reader, but the size of D2R transmission actually performed by the device may vary depending on a factor, such as channel coding and a CRC length.

The reader may indicate a chip length, Tc 1217, to the device. Tc 1217 may be a specific time length, or may be indicated by an indicator indicating one or more values from a list of available values.

Some D2R transmission parameters (e.g., TBS and Tc) in R2D transmission may be indicated with the same values for all D2R transmissions, but are not limited thereto. For example, a different value may be indicated separately for each TB or each D2R transmission. For example, an offset value may be indicated based on a value for one TB or D2R transmission to calculate values for different TBs or D2R transmissions.

The reader may indicate a value of M 1218 and 1219 to the device. The value of M 1218 and 1219 may determine the number of repetitions of a subcarrier sequence or Manchester code, thereby affecting the number of chips belonging to the length of one symbol (Tb) and the chip length, and may also affect a frequency resource for D2R transmission.

The reader may indicate M1 1218 and M2 1219 to apply different values of M to the two repeated transmissions, respectively. For each TB, a value of MI may be applied as the value of M to first repeated transmission, and a value of M2 may be applied as the value of M to second repeated transmission.

A transmission parameter not specifically included in the transmission of the initial R2D signal 1200 may be configured the same for all D2R transmissions, or may be determined depending on some indicators within the ID field.

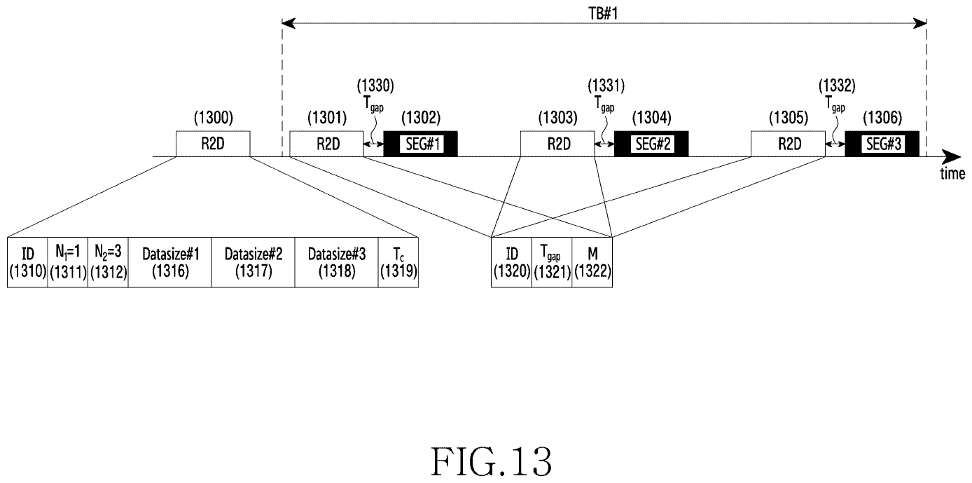

FIG. 13 illustrates when a parameter in an R2D signal transmitted by a reader indicates transmission of a D2R signal of a device according to an embodiment.

Referring to FIG. 13, an R2D signal 1300 initially transmitted by the reader may indicate a report on specific information to the device.

The reader may indicate D2R transmission for a single TB and indicate transmission of the TB using three segmented transmissions to the device.

The initially transmitted R2D signal 1300 may include an ID field 1310 indicating information about the device or a message. For example, the ID field 1310 may include information, such as an ID of the device, an ID of a device group, an ID recognizable by all devices receiving the ID field, or a random ID, thereby controlling a device group receiving the message. The ID field may also include an indicator indicating the format of the R2D transmission. For example, the indicator indicating the format of the R2D transmission may indicate the format of the R2D transmission, thereby enabling the device to identify information included in the R2D transmission with a relatively small number of bits (e.g., one bit).

The ID field 1310 may also include information about a transmission method that D2R transmission follows. For example, the ID field may include information indicating various transmission methods, such as repeated transmission, segmented transmission, and periodic transmission. For example, referring to FIG. 13, the reader may indicate D2R transmission for a total of N1=1 1311 TB and indicate N2=3 1312 repeated transmissions for each TB to the device. For example, after receiving the R2D signal 1300, the device may perform a total of three D2R transmissions accordingly.

The reader may transmit D2R transmission parameters dividedly to the device by using additional R2D transmissions 1301, 1303, and 1305, instead of transmitting all D2R transmission parameters at once by using initial R2D transmission 1300. First, the reader may indicate a data size (Datasize #1 1316, Datasize #2 1317, and Datasize #3 1318) corresponding to each segmented transmission through the initial R2D transmission 1300.

The reader may indicate a TBS for one TB to the device, and the device may determine the size of data to be transmitted in each segmented transmission by using an agreed calculation equation or table.

A method of transmitting an indicator according to a predetermined table may be used. A method by which the reader indicates a TBS to the device is not limited to the foregoing example.

The reader may indicate a chip length, Tc 1319, to the device. Tc 1319 may be a specific time length, or may be indicated by an indicator indicating one or more values from a list of available values. Although FIG. 13 illustrates when Tc is the same value for all D2R transmissions, the disclosure is not limited thereto. For example, a different Tc value may be applied to each D2R transmission by indicating a new Tc value in subsequent additional R2D transmission.

The reader may perform the additional R2D transmissions 1301, 1303, and 1305 to the device, thereby indicating a timing at which each segmented transmission starts and the value of M 1322 to be used for the corresponding D2R transmission. It is assumed in FIG. 13 that all three additional R2D transmissions 1301, 1303, and 1305 have the same transmission parameters, but the transmission parameters included in each of the additional R2D transmissions 1301, 1303, and 1305 are not limited thereto. For example, the additional R2D transmissions 1301, 1303, and 1305 may include different combinations of transmission parameters. Although FIG. 13 illustrates when each of the additional R2D transmissions 1301, 1303, and 1305 includes scheduling information for single D2R transmission, the disclosure is not limited thereto. For example, single additional R2D transmission may include scheduling information for a plurality of D2R transmissions. When the single additional R2D transmission includes the scheduling information for the plurality of D2R transmissions, a combination of transmission parameters included in each R2D transmission may be identified by identifying an ID field 1320 of each R2D combination.

The device may determine timings 1330, 1331, and 1332 indicating segmented transmissions after receiving the additional R2D by referring to Tgap 1321 in the additional R2D transmissions 1301, 1303, and 1305.

Alternatively, according to one embodiment, Tgap may be replaced with periodicity information of each D2R transmission. In this case, the periodicity information of each D2R transmission may include information regarding, for example, an interval between the start times of consecutive D2R transmissions.

The reader may indicate the value of M 1322 to the device. The value of M 1322 may determine the number of repetitions of a subcarrier sequence or Manchester code, thereby affecting the number of chips belonging to the length of one symbol (Tb) and the chip length, and may also affect a frequency resource for D2R transmission.

The reader may indicate the value of M 1322 for D2R transmission through each of the R2D transmissions 1301, 1303, and 1305, thereby changing the value of M used for each of the segmented transmissions 1302, 1304, and 1306. For example, some D2R transmission parameters in the R2D transmission may be indicated with the same value for all D2R transmissions. Alternatively, a different value may be indicated separately for each TB or each D2R transmission, or an offset value may be indicated based on a value for one TB or D2R transmission to calculate values for different TBs or D2R transmissions. A transmission parameter not specifically included in the R2D transmission may be configured the same for all D2R transmissions, or may be determined depending on some indicators within the ID field.

Information that may be included in the transmission parameters and the ID fields 1310 and 1320 may be presented in different combinations or configurations. In addition, the information may actually be indicated as a separate D2R transmission parameter within the R2D transmission rather than in the ID fields 1310 and 1320. The orders and combinations of the transmission parameters illustrated in FIG. 9 to FIG. 13 are only for illustration, and do not limit R2D transmission that may actually be performed. In addition, transmission of some information among the parameters illustrated in FIG. 9 to FIG. 13 may be omitted or added.

### Embodiment 3: Case in which Device Requests D2R Segmented Transmissions

Since a device is a device that operates based on energy harvesting, the device may not always have sufficient energy for data transmission. For example, when the size of data of which transmission is indicated to the device is 1,000 bits, energy that the device has may not be sufficient to transmit 1,000 bits. In this case, the device may transmit a message for requesting segmented transmissions of the data to the reader. In this case, the reader may retransmit information necessary for the segmented transmissions to the device. Alternatively, the device may autonomously transmit a portion of data transmittable considering the retained energy among the total of 1000-bit data first, and may report information thereabout together to the reader. After identifying the information, the reader may either transmit information necessary to transmit the remaining data to the device or transmit a command to discard the remaining data.

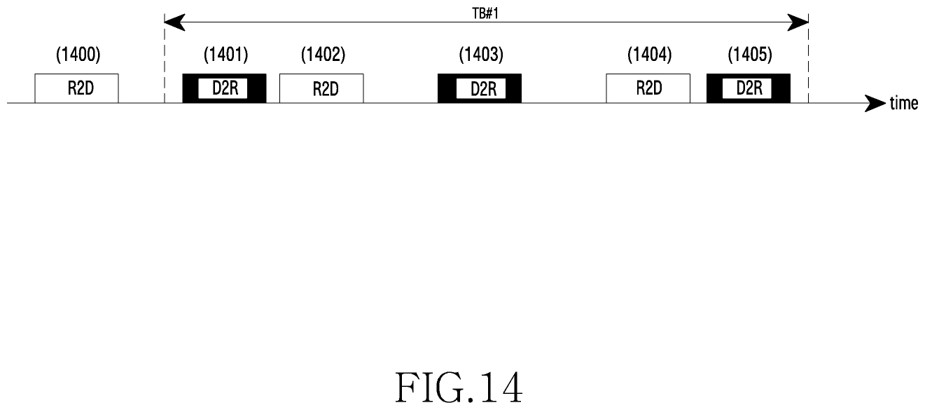

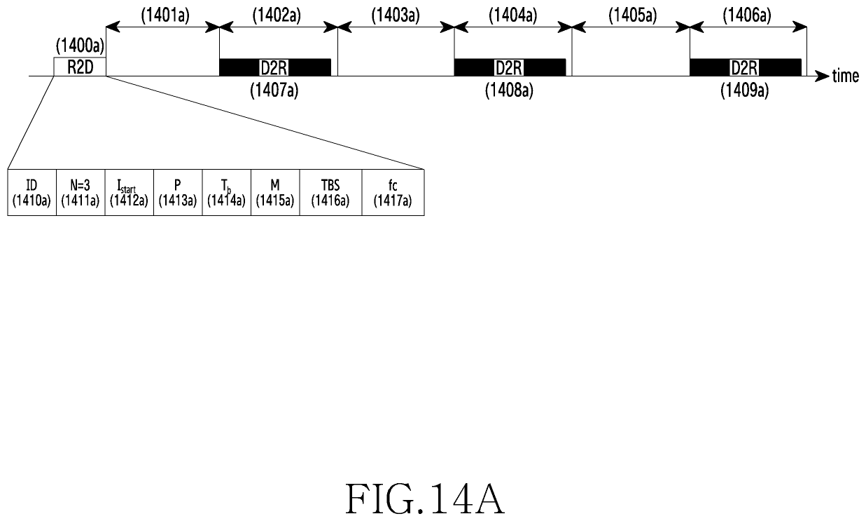

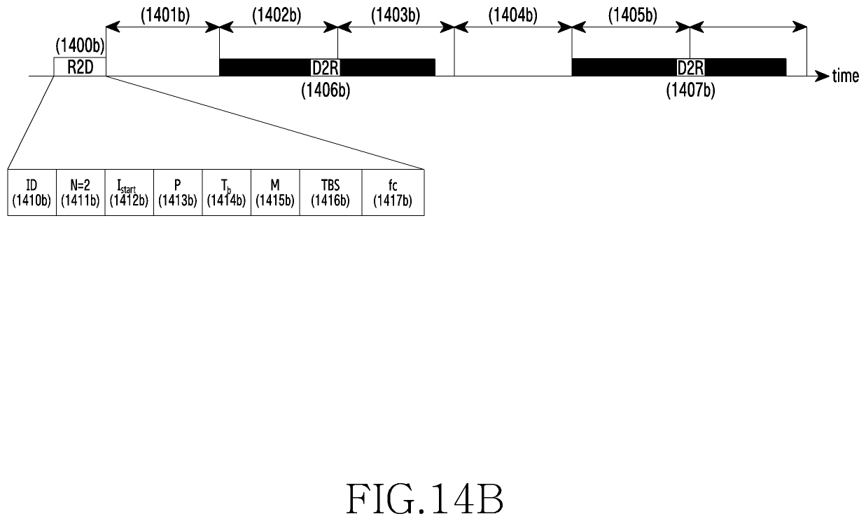

FIG. 14 illustrates when a parameter in an R2D signal transmitted by a reader indicates transmission of a D2R signal of a device according to an embodiment.

Referring to FIG. 14, the device may receive R2D data 1400 from the reader, and receive an indication to transmit data of a certain size.

The device may have difficulty transmitting the data of the indicated size to the reader via single D2R transmission due to an internal hardware problem or an energy problem as described above. When it is difficult to transmit the data of the indicated size the reader via single D2R transmission, the device may report information indicating difficulty in transmitting the data of the indicated size to the reader via single D2R transmission through D2R transmission 1401. For example, the report from the device may use a method of transmitting data with a size less than or equal to a maximum data size allowed for the device together with report information. For example, the device may transmit only content of the report to the reader via D2R transmission 1401 without transmitting data.

The report information from the device may include energy state information about the data. For example, the report information from the device may include information related to energy harvesting efficiency, energy retained by the device, or energy charging time required for transmission of the entire data. In this case, the device may maintain the data held without deleting the data until receiving an additional instruction from the reader.

Upon receiving the report from the device, the reader may perform additional R2D transmission 1402 to indicate segmented transmission of a portion of the data to the device.

According to an embodiment, based on the report, the device may perform D2R transmission 1403 including only a portion of data newly indicated among the entire data previously indicated by the reader to the reader.

When there is still remaining data to be transmitted among the entire data previously indicated by the reader, the device may wait for an additional indication from the reader without deleting the data. When the reader indicates deletion of the data through the previous R2D transmission, the device may delete the data and wait for new R2D transmission even though there is the remaining data.

When the device does not delete the data and waits for the additional indication from the reader, the reader may perform additional R2D transmission 1404 to the device.

After receiving the additional R2D transmission 1404 to identify scheduling information, the device may transmit the remaining data, and may then operate focusing on energy harvesting without maintaining remaining scheduling configuration data. For example, the device may perform D2R transmission 1405 including the remaining data. Some of the operations described with reference to the example illustrated in FIG. 14 may be deleted or repeatedly added in an embodiment of the disclosure, and scheduling information included in R2D transmission may include the scheduling information described above with reference to FIG. 11 to FIG. 13.

FIG. 14a illustrates an example of indicating a D2R transmission based on parameters within an R2D transmission according to an embodiment of the present disclosure.

According to one embodiment, a device may receive an R2D transmission 1400a including control information from a reader and set (or identify) the received R2D transmission 1400a as a timing reference. Based on the established (or identified) timing reference, the device may identify consecutive time resources having a pre-defined length or a time duration indicated by the reader. For example, the device may identify a plurality of slots 1401a, 1402a, 1403a, 1404a, 1405a, and 1406a. The device may sequentially set (or identify) local time indexes corresponding to each of the identified plurality of slots 1401a, 1402a, 1403a, 1404a, 1405a, and 1406a (for example, i=0, 1, 2, . . . , 5). The R2D transmission 1400a may instruct the device (e.g., the device 302 of FIG. 3) to perform at least one of periodic reporting, repetitive transmission, and/or segmented transmission of specific information.

According to one embodiment, the R2D transmission 1400a may include an ID field 1410a for indicating information about the device (e.g., the device 302 of FIG. 3) or the message. The ID field 1410a may include ID information such as an ID of the device (e.g., the device 302 of FIG. 3), an ID of a group to which the device belongs, an ID recognizable by all devices receiving the R2D transmission 1400a, and/or a random ID. Accordingly, the reader may control the group of devices that receive the message.

According to one embodiment, the ID field 1410a may include an indicator for indicating a format of the R2D transmission. For example, the indicator for indicating the format of the R2D transmission may enable the device (e.g., the device 302 of FIG. 3) to identify what type of information is included in the R2D transmission by using a relatively small number of bits (e.g., one bit).

According to one embodiment, the R2D transmission 1400a may include a field for indicating the number of D2R transmissions to be performed by the device (e.g., the device 302 of FIG. 3). For example, referring to FIG. 14a, the reader (e.g., the reader 300 of FIG. 3) may instruct the device (e.g., the device 302 of FIG. 3) to perform a total of N=3 D2R transmissions 1407a, 1408a, and 1409a (1411a). In this case, a local time index Istart 1412a of the slot 1402a where the first D2R transmission 1407a starts may be indicated.

According to one embodiment, the R2D transmission 1400a may include information for indicating periodicity information P 1413a. For example, when Istart=1 and P=2, D2R transmissions may be initiated in the slot 1402a corresponding to the local time index 1 and in the slots 1404a and 1406a determined according to the periodicity information P 1413a indicating a period (or offset) of P=2 relative to the slot 1402a.

According to one embodiment, the R2D transmission 1400a may include Tb 1414a indicating a time length required for transmitting one data bit in D2R transmission, TBS 1416a, and/or an M value 1415a for determining an actual chip length used for transmission.

According to one embodiment, the R2D transmission 1400a may include fc 1417a for indicating a center frequency or reference frequency at which the D2R transmission is to be performed. The actual physical duration of each D2R transmission may be determined by at least one parameter such as Tb, M value, and/or TBS. Each D2R transmission may be included within the length of a single slot, but is not limited thereto. For example, each D2R transmission may be included across two or more slots.

FIG. 14b is a diagram for explaining a scheduling method of D2R transmission according to an embodiment of the present disclosure.

In one embodiment, when the unit of a time slot is set relatively long to improve system resource efficiency, the efficiency of D2R transmission may decrease.

The present disclosure may provide a D2R transmission method applicable when a total transmission time required for a single D2R transmission is longer than the length of a basic time resource unit, i.e., a slot.

According to one embodiment, a device may receive an R2D transmission 1400b including control information from a reader and set (or identify) the received R2D transmission 1400b as a timing reference. Based on the established (or identified) timing reference, the device may identify consecutive time resources having a pre-defined length or a time duration indicated by the reader. For example, the device may identify a plurality of slots 1401b, 1402b, 1403b, 1404b, 1405b, and 1406b. The device may sequentially set (or identify) local time indexes corresponding to each of the identified plurality of slots 1401b, 1402b, 1403b, 1404b, 1405b, and 1406b (for example, i=0, 1, 2, . . . , 5). The R2D transmission 1400b may instruct the device (e.g., the device 302 of FIG. 3) to perform at least one of periodic reporting, repetitive transmission, and/or segmented transmission of specific information.

According to one embodiment, the R2D transmission 1400b may include an ID field 1410b for indicating information about the device (e.g., the device 302 of FIG. 3) or a message.

The ID field 1410b may include ID information such as an ID of the device (e.g., the device 302 of FIG. 3), an ID of a group to which the device belongs, an ID recognizable by all devices receiving the R2D transmission 1400b, and/or a random ID. Accordingly, the reader may control a group of devices that receive the message.

According to one embodiment, the ID field 1410b may include an indicator for indicating a format of the R2D transmission. For example, the indicator for indicating the format of the R2D transmission may enable the device (e.g., the device 302 of FIG. 3) to identify what type of information is included in the R2D transmission using a relatively small number of bits (e.g., one bit).

According to one embodiment, the R2D transmission 1400b may include a field for indicating the number of D2R transmissions to be performed by the device (e.g., the device 302 of FIG. 3). For example, referring to FIG. 14b, the reader (e.g., the reader 300 of FIG. 3) may instruct the device (e.g., the device 302 of FIG. 3) to perform a total of N=2 D2R transmissions 1406b and 1407b (1411b). In this case, a local time index Istart 1412b of the slot 1402b where the first D2R transmission 1406b starts may be indicated.

According to one embodiment, the R2D transmission 1400b may include information for indicating periodicity information P 1413b. For example, when Istart=1 and P=3, D2R transmissions may be initiated in the slot 1402b corresponding to the local time index 1 and in the slot 1405b determined according to the periodicity information P 1413b indicating a period (or offset) of P=3 relative to the slot 1402b.

According to one embodiment, the R2D transmission 1400b may include Tb 1414b indicating a time length required for transmitting one data bit in D2R transmission, TBS 1416b, and/or an M value 1415b for determining an actual chip length used for transmission.

According to one embodiment, the R2D transmission 1400b may include fc 1417b for indicating a center frequency or reference frequency at which the D2R transmission is to be performed. The actual physical duration of each D2R transmission may be determined by at least one parameter such as Tb, M value, and/or TBS. Each D2R transmission may be included within the length of a single slot, but is not limited thereto. For example, each D2R transmission may extend over two or more slots.

According to one embodiment, the device may continuously transmit a signal for a total required transmission time regardless of slot boundaries. For example, a single D2R transmission (e.g., the D2R transmission 1406b of FIG. 14b) may be performed over portions of two or more slots (e.g., the slots 1402b and 1403b of FIG. 14b).

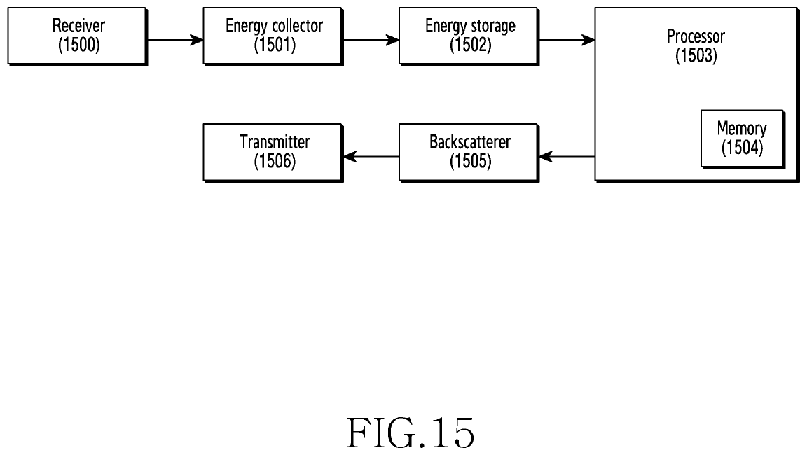

FIG. 15 illustrates a device in a wireless communication system according to an embodiment.

Referring to FIG. 15, the device according to the embodiment may include a transceiver 1500 and 1506, which refers to a receiver 1500 of the device and a transmitter 1506 of the device, a memory 1504, and a device processor (or device controller or processor) 1503.

A low-power device may include an energy collector 1501 to support energy harvesting and an energy storage 1502.

When the device receives a CW transmitted from the outside and generates a D2R signal by reflecting the CW, a backscatterer 1505 required to use backscattering may be included in the device, the disclosure is not limited thereto. For example, the device may directly generate a signal internally, and when the device generates a D2R signal internally, no backscatterer 1505 may be included in the device.

The device transmitter 1506, the receiver 1500, the energy collector 1501, the energy storage 1502, the backscatterer 1505, the memory 1504, and the device processor 1503 may operate according to a communication method of the device. For example, the device processor (or processor) 1503 may control an operation of the device according to not only each of the embodiments described above with reference to FIG. 1 to FIG. 14 but also a combination of at least one embodiment.

Components of the device according to the disclosure are not limited to those illustrated in FIG. 15. For example, the device may include more or fewer components than those illustrated in FIG. 15. The transceiver 1500 and 1506, the memory 1504, and the processor 1503 may be configured in the form of a single chip.

The transceiver 1500 and 1506 may transmit and receive a signal to and from a reader. The signal which the device transmits to and receives from the reader via the transceiver 1500 and 1506 may include control information and data. To this end, the transceiver 1500 and 1506 may include an RF transmitter that upconverts and amplifies the frequency of a transmitted signal and an RF receiver that performs low-noise amplification on a received signal and downconverts the frequency of the received signal, but is not limited thereto. Components of the transceiver 1500 and 1506 are not limited to the RF transmitter and the RF receiver.

The transceiver units 1500 and 1506 may receive a signal via a wireless channel to output the signal to the processor 1503, and may transmit a signal output from the processor 1503 via the wireless channel.

The memory 1504 may store a program and data necessary for the operation of the device. In addition, the memory 1504 may store control information or data included in a signal transmitted and received by the device. The memory 1504 may be configured as a storage medium, such as a read only memory (ROM), a random access memory (RAM), a hard disk, a compact disc ROM (CD-ROM), and a digital versatile disc (DVD), or a combination of storage media. A plurality of memories 1504 may be included.

The processor 1503 may control a series of processes so that the device may operate according to the foregoing embodiments. For example, there may be a plurality of processors 1503, and the processor 1503 may perform an operation of controlling a component of the device by executing a program stored in the memory 1504.

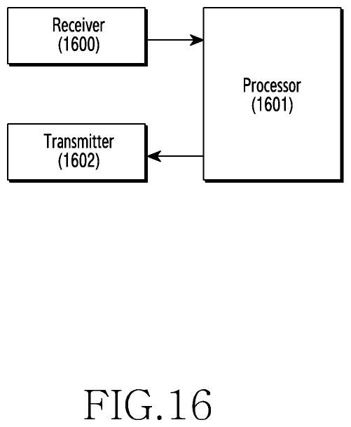

FIG. 16 illustrates a reader in a wireless communication system according to an embodiment. The reader described with reference to FIG. 16 may include a base station, a UE, or a device designed only for a low-power communication device in the wireless communication system.

Referring to FIG. 16, the reader may include a transceiver 1600 and 1602, which refers to a receiver 1600 of the reader and a transmitter 1602 of the reader, a memory, and a reader processor 1601. Herein, the processor 1601 of the reader may be referred to as a “reader processor,” a “reader controller,” or a “processor.”

The transceiver 1600 and 1602, the memory, and the reader processor 1601 of the reader may operate according to a communication method of the reader described above with reference to FIGS. 1 to 14. For example, the reader processor 1601 may control an operation of the reader according to not only each of the embodiments described above with reference to FIGS. 1 to. 14 but also a combination of at least one embodiment. Components of the reader are not limited to the foregoing examples. For example, the reader may include more or fewer components than those illustrated in FIG. 16. The transceiver 1600 and 1602, the memory, and the processor 1601 of the reader may be configured in the form of a single chip.

The transceiver 1600 and 1602 may transmit and receive a signal to and from a device. The signal which the reader transmits to and receives from the device via the transceiver 1600 and 1602 may include control information and data. To this end, the transceiver 1600 and 1602 may include an RF transmitter that upconverts and amplifies the frequency of a transmitted signal and an RF receiver that performs low-noise amplification on a received signal and downconverts the frequency of the received signal, but is not limited thereto. Components of the transceiver 1600 and 1602 are not limited to the RF transmitter and the RF receiver.

The transceiver units 1600 and 1602 may receive a signal via a wireless channel to output the signal to the processor 1601, and may transmit a signal output from the processor 1601 via the wireless channel.

The memory (not shown) may store a program and data necessary for the operation of the reader. In addition, the memory may store control information or data included in a signal transmitted and received by the reader. The memory may be configured as a storage medium, such as a ROM, a RAM, a hard disk, a CD-ROM, and a DVD, or a combination of storage media. The reader may include a plurality of memories.

The processor 1601 may control a series of processes so that the reader may operate according to the foregoing embodiments of the disclosure. For example, there may be a plurality of processors 1601, and the processor 1601 may perform an operation of controlling a component of the reader by executing a program stored in the memory.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

Methods disclosed in the claims and/or methods according to the embodiments described in the specification of the disclosure may be implemented by hardware, software, or a combination of hardware and software.

When various embodiments of the disclosure are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure.

These programs (software modules or software) may be stored in non-volatile memories including a random access memory and a flash memory, a ROM, an electrically erasable programmable read only memory (EEPROM), a magnetic disc storage device, a CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

The programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. A separate storage device on the communication network may access a portable electronic device.

While the disclosure has been particularly shown and described with reference to certain embodiments thereof, it will be understood by those of ordinary skill in the art that various changes in form and details may be made therein without departing from the spirit and scope of the disclosure as defined by the following claims and their equivalents.

What is claimed is:

1. A method performed by a reader in a wireless communication system, the method comprising:
transmitting, to a device, a reader-to-device (R2D) message including configuration information for a plurality of device-to-reader (D2R) messages; and
receiving, from the device, the plurality of D2R messages based on the configuration information,
wherein the configuration information includes scheduling information for scheduling the plurality of D2R messages, and
wherein the scheduling information is based on a chip duration.

2. The method of claim 1,
wherein the chip duration is a minimum time duration corresponding to an element of a sequence for representing a single bit.

3. The method of claim 1,
wherein each of the plurality of D2R messages includes identical data and is repeatedly received.

4. The method of claim 1,
wherein each of the plurality of D2R messages includes segmented data of a single transport block.

5. The method of claim 1,
wherein each of the plurality of D2R messages is periodically received.

6. The method of claim 3,
wherein the scheduling information includes information on a transmission start timing of the plurality of D2R messages, a gap between two D2R messages of the plurality of D2R messages, and a number of the plurality of D2R messages.

7. The method of claim 4,
wherein the scheduling information includes a size of the segmented data.

8. The method of claim 5,
wherein the scheduling information includes a period of the plurality of D2R messages.

9. The method of claim 1,
wherein each of the plurality of D2R messages is triggered by a corresponding R2D message.

10. The method of claim 1,
wherein the plurality of R2D messages is received based on a request for a permission of a segmented transmission from the device.

11. A method performed by a device in a wireless communication system, the method comprising:
receiving, from a reader, a reader-to-device (R2D) message including configuration information for a plurality of device-to-reader (D2R) messages; and
transmitting, to the device, the plurality of D2R messages based on the configuration information,
wherein the configuration information includes scheduling information for scheduling the plurality of D2R messages, and
wherein the scheduling information is based on a chip duration.

12. A reader comprising:
at least one transceiver;
at least one processor communicatively coupled to the at least one transceiver; and
at least one memory, communicatively coupled to the at least one processor, storing instructions executable by the at least one processor individually or in any combination to cause the reader to:
transmit, to a device, a reader-to-device (R2D) message including configuration information for a plurality of device-to-reader (D2R) messages; and
receive, from the device, the plurality of D2R messages based on the configuration information,
wherein the configuration information includes scheduling information for scheduling the plurality of D2R messages, and
wherein the scheduling information is based on a chip duration.

13. The reader of claim 12,
wherein the chip duration is a minimum time duration corresponding to an element of a sequence for representing a single bit.

14. The reader of claim 12,
wherein each of the plurality of D2R messages includes identical data and is repeatedly received.

15. The reader of claim 12,
wherein each of the plurality of D2R messages includes segmented data of a single transport block.

16. The reader of claim 12,
wherein each of the plurality of D2R messages is periodically received.

17. The reader of claim 14,
wherein the scheduling information includes information on a transmission start timing of the plurality of D2R messages, a gap between two D2R messages of the plurality of D2R messages, and a number of the plurality of D2R messages.

18. The reader of claim 15,
wherein the scheduling information includes a size of the segmented data.

19. The reader of claim 16,
wherein the scheduling information includes a period of the plurality of D2R messages.

20. A device comprising:
at least one transceiver;
at least one processor communicatively coupled to the at least one transceiver; and
at least one memory, communicatively coupled to the at least one processor, storing instructions executable by the at least one processor individually or in any combination to cause the device to:
receive, from a reader, a reader-to-device (R2D) message including configuration information for a plurality of device-to-reader (D2R) messages; and
transmit, to the device, the plurality of D2R messages based on the configuration information,
wherein the configuration information includes scheduling information for scheduling the plurality of D2R messages, and
wherein the scheduling information is based on a chip duration.
